(19) United States
(12) Patent Application Publication
(10) Pub. No.: US 2021/0048977 A1
(43) Pub. Date: Feb. 18, 2021

(54) METHOD OF SETTING BUTTON FUNCTION FOR DEVICE AND SETTING APPARATUS

(71) Applicant: Tymphany Acoustic Technology Limited, TAIPEI CITY (TW)

(72) Inventor: Che-Ching LIEN, TAIPEI CITY (TW)

(21) Appl. No.: 16/994,022

(22) Filed: Aug. 14, 2020

(30) Foreign Application Priority Data
Aug. 14, 2019 (CN) 201910750266.0

(51) Int. Cl. G06F 3/16

(52) U.S. Cl. CPC G06F 3/165; H04W 84/12

(57) ABSTRACT

A method of setting a button function for a device, includes automatically setting a wildcard button for the device with a function according to an operational status of the device. The automatically setting includes determining whether a current operational status of the device pertains to a preset operational status in a case where the wildcard button for the device is pressed and is not configured with a button function and configuring the wildcard button with a button function corresponding to the preset operational status when the current operational status of the device pertains to the preset operational status. With the technical solution of the present application, the wildcard button may still work automatically and smartly even though the wildcard button is not configured with a function, and the wildcard button may be configured without using a mobile app or a network connection.

### CROSS REFERENCE TO RELATED APPLICATIONS

The present application claims priority to Chinese Patent Application No. CN 201910750266.0, which was filed on Aug. 14, 2019 the entire contents of which are hereby incorporated by reference.

### TECHNICAL FIELD

The application relates to the technical field of electronics, and in particular to a method of setting button function for device and setting apparatus.

### BACKGROUND

Generally, button functions of devices, such as loudspeakers, are fixed after shipment. End users using the loudspeakers cannot change the button functions by their favors.

Additionally, there is a method at present that may change specific button functions by applications (apps) of smart devices (such as smart phones). However, such a method needs to set networks, connect the apps, then find menus, complete specific settings and the like on the smart devices, which is inconvenient for operation in use.

For many consumer devices, which have neither networks nor phone apps, there is a need for a method of changing the button functions.

### SUMMARY OF THE APPLICATION

In view of the above-mentioned problems in the relevant art, the application provides a method of setting a button function for a device, a setting apparatus for the button function and a storage medium, which can enable a wildcard button to still work smartly when a button function of the wildcard button is not configured, and which does not need to use an app or connect a network to set the button function of the wildcard button.

The technical solution of the present application is implemented as follows.

According to an aspect of the present invention, a method of setting a button function for a device is provided, which includes automatically setting a wildcard button for the device with a function based on an operational status of the device. The automatically setting includes determining whether a current operational status of the device pertains to a preset operational status in a case where the wildcard button of the device is pressed and is unconfigured with a button function and configuring the wildcard button with a button function corresponding to the preset operational status when the current operational status of the device pertains to the preset operational status.

According to an embodiment of the present application, the determining whether the current operational status of the device pertains to the preset operational status is implemented by when a plurality of preset operational statuses are provided, the device automatically and sequentially determines whether the current operational status is one of the plurality of preset operational statuses.

According to an embodiment of the present application, the preset operational status includes a first preset operational status. The first preset operational status is a status in which a WiFi mode is provided and a WiFi configuration is uncompleted, and a function corresponding to the first preset operational status is a function for start WiFi configuration.

According to an embodiment of the present application, the preset operational status comprises a second preset operational status, the second preset operational status is a status in which a Bluetooth audio mode is provided and a Bluetooth is unpaired, and a function corresponding to the second preset operational status is a function for Bluetooth pairing.

According to an embodiment of the present application, the preset operational status comprises a third preset operational status, the third preset operational status is a status in which the device is in a system error, and a function corresponding to the third preset operational status is a function for system reset.

According to an embodiment of the present application, switching the device to a human-machine interaction setting mode when the current operational status of the device does not pertain to the preset operational status; and in the human-machine interaction setting mode, configuring the wildcard button with a button function chosen by a user under an environment without a network and/or a mobile application.

According to an embodiment of the present application, the configuring a button function selected by a user to the wildcard button includes, during a voice menu prompt, choosing, by the user, by using a voice command or pressing the wildcard button, the button function to be configured to the wildcard button.

According to an embodiment of the present application, in the human-machine interaction setting mode, the button function chosen by the user is any one of Bluetooth pairing, WiFi connection, mute, or play/pause.

According to another aspect of the present invention, a setting apparatus for a button function is provided, including an automatic setting module, the automatic setting module automatically setting a wildcard button for the device with a function according to an operational status of a device having a wildcard button. The automatic setting module includes a determination module, configured to determine whether a current operational status of the device pertains to a preset operational status in a case where the wildcard button is pressed and is not configured with a button function and a configuration module, configured to configure the wildcard button with a button function corresponding to the preset operational status when the current operational status of the device pertains to the preset operational status.

According to an embodiment of the present application, the preset operational status includes a first preset status, a second preset status and a third preset status. The first preset operational status is a status in which a WiFi mode is provided and a WiFi configuration is uncompleted and a function corresponding to the first preset operational status is a function for start WiFi configuration. The second preset operational status is a status in which a Bluetooth audio mode is provided and a Bluetooth is unpaired and a function corresponding to the second preset operational status is a function for Bluetooth pairing. The third preset operational status is a status in which the device is in a system error and a function corresponding to the third preset operational status is a function for system reset.

According to an embodiment of the present application, the setting apparatus for a button function further includes a human-machine interaction setting module, wherein when the determination module determines that the current operational status of the device is not the preset operational status, the human-machine interaction setting module configures the wildcard button with a button function chosen by a user under an environment without a network and/or a mobile application.

According to an embodiment of the present application, the human-machine interaction setting module includes a button function choosing module, configured to choose, in response to that the user uses a voice command or presses the wildcard button during a voice menu prompt, the button function to be configured to the wildcard button.

According to yet another aspect of the present invention, a storage medium is provided, storing a program executing the program to complete the above method.

The application has the following beneficial effects.

When determining that the current operational status of a device pertains to the preset operational status, by configuring the wildcard button with a button function corresponding to the preset operational status, the application can automatically configure a function required by the current operational status to the wildcard button according to the current operational status of the device; and thus, even though the wildcard button is not configured with a function, the wildcard button may still work automatically and smartly.

In addition, the wildcard button may be configured as a function commonly used by an end user or a function favored by the user without a network or a mobile app.

### BRIEF DESCRIPTION OF THE ACCOMPANYING DRAWINGS

In order to illustrate the technical solutions in the embodiments of the present application in the prior art more clearly, the drawings which are required to be used in the description of the embodiments of the present application are briefly described below. It is obvious that the drawings described below are only some embodiments of the present disclosure. It is apparent to those skilled in the art that other drawings may be obtained based on the accompanying drawings without giving inventive effort.

FIG. 1 illustrates a flowchart of a method of presetting and running a button function for a device according to an embodiment of the application.

FIG. 2 illustrates a flowchart of a method of performing default or user setting on a button function for a device according to an embodiment of the application.

FIG. 3 illustrates a detailed flowchart of a method of performing default or user setting on a button function for a device according to a specific embodiment of the application.

FIG. 4 illustrates a block diagram of a presetting apparatus for a button function according to an embodiment of the application.

FIG. 5 illustrates a block diagram of a default and user setting apparatus for a button function according to an embodiment of the application.

### DETAILED DESCRIPTION OF THE PREFERRED EMBODIMENTS

The technical solutions of the embodiments of the present application will be clearly and completely described in the following with reference to the accompanying drawings. It is obvious that the embodiments to be described are only a part the embodiments of the present application rather than all of the embodiments of the present application. All other embodiments obtained by the skilled in the art based on the embodiments of the present application are within the protection scope of the present application.

According to an embodiment of the application, a method 100 of setting a button function for a device is provided. As shown in FIG. 1, the method 100 includes automatically setting a function of a wildcard button of a device according to an operational status of the device. The automatically setting may include the following steps:

S102: in a case where the wildcard button of the device is pressed and is not configured (unconfigured) with a button function, determine a current operational status of the device and determine whether the current operational status of the device pertains to a preset operational status. It should be understood that the wildcard button is a button not configured with a function for the first Out-of-Box use or after factory reset. Hence, the function of the wildcard button may be configured by an end user. The device with the wildcard button may be, for example, a loudspeaker.

S104, configure the wildcard button with a button function corresponding to the preset operational status when determining that the current operational status of the device pertains to the preset operational status.

According to the above technical solutions of the application, when determining that the current operational status of a device pertains to the preset operational status, by configuring the wildcard button with a button function corresponding to the preset operational status, the application can automatically configure a function required by the current operational status to the wildcard button according to the current operational status of the device and, thus, even though the wildcard button is not configured with a function, the wildcard button may still work automatically and smartly.

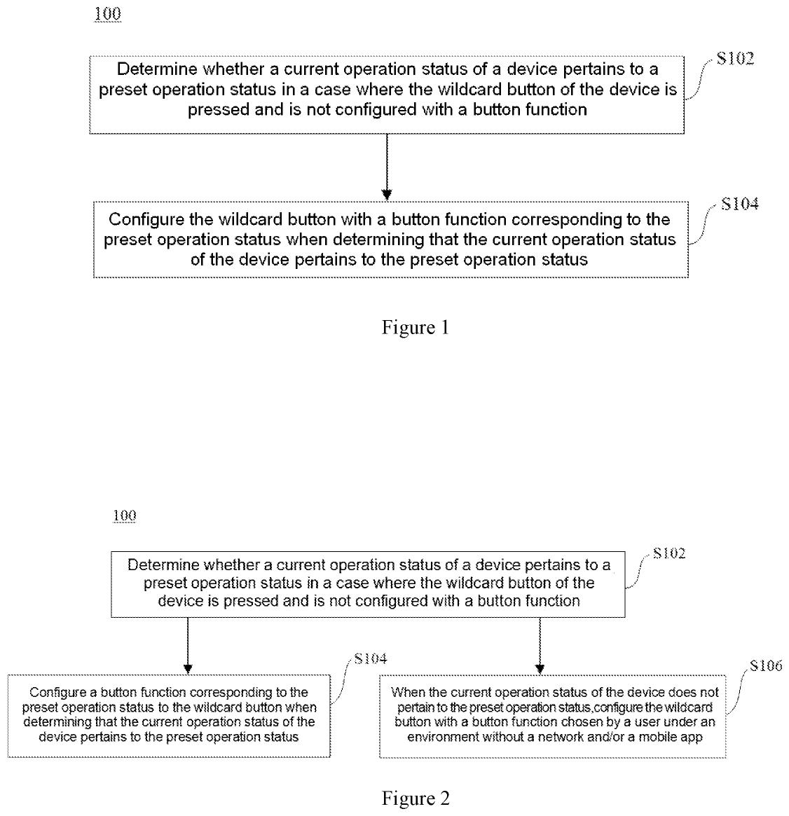

Referring to FIG. 2, in some embodiments, when the current operational status of the device does not pertain to the preset operational status, the method 100 executes step S106. That is, when the current operational status of the device does not pertain to the preset operational status, switching the device to step S106 of a human-machine interaction setting mode configuring the wildcard button with a button function chosen by a user under an environment without a network and/or a mobile app. Therefore, the wildcard button may be configured as a function commonly used by an end user or a function favored by the user without the network or the mobile app.

In an embodiment, at step S106, configuring the wildcard button with the button function chosen by the user may include: the user chooses the button function to be configured to the wildcard button by using a voice command or pressing the wildcard button during a voice menu prompt. Prompting the voice menu may enable the end user to choose the button function by means of a favor or a habit. The end user may further use the voice command or press the button to select the function during prompting the voice menu, and after the selection is done, the device may store the function setting chosen by the end user and configures the wildcard button with the chosen function. In some embodiments, the button function chosen by the user may be any one of Bluetooth™ pairing, WiFi™ connection, mute, play and pause. In other embodiments, the button function may also be any other appropriate functions, and is not to be limited by the application.

In some embodiments, the number of preset operational statuses may be more than one. Specifically, when a plurality of preset operational statuses are provided, the device automatically and sequentially determines whether the current operational status is one of the plurality of preset operational statuses. The number and type of the preset operational statuses may be determined according to a specific application of the device, and are not to be limited by the application.

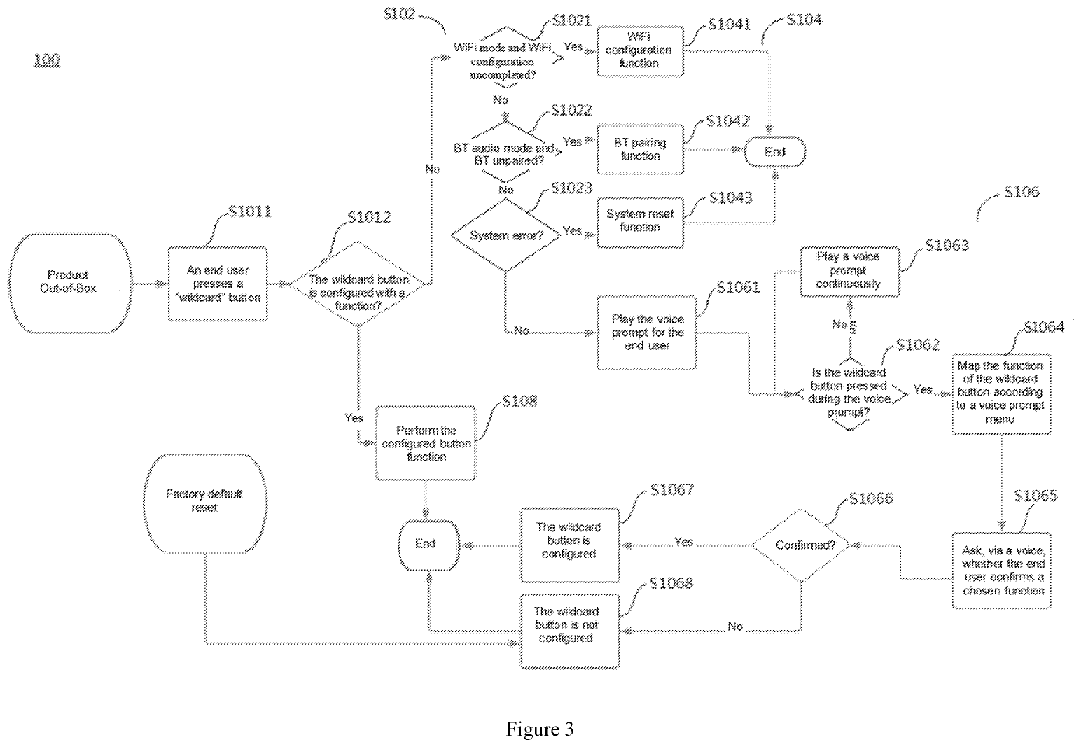

FIG. 3 illustrates a detailed flowchart of a method 100 of setting a button function for a device according to a specific embodiment of the application.

Referring to FIG. 3, at step S1011, after the end user presses the wildcard button, execute step S1012.

At step S1012, determine whether the wildcard button is configured with a button function. If not, that is, the wildcard button is not configured with the button function, execute step S102; and if yes, that is, the wildcard button is configured with the button function, execute step S108 of performing the button function configured to the wildcard.

At step S102, determine a current operational status of a device, and determine whether the current operational status of the device pertains to a preset operational status. When it is determined that the current operational status of the device pertains to the preset operational status, execute step S104 of configuring the wildcard button with a button function corresponding to the preset operational status.

In this embodiment, the preset operational status may include a first preset operational status, the first preset operational status is a status in which a WiFi mode is provided and the WiFi configuration is uncompleted, and a function corresponding to the first preset operational status is a function for start WiFi configuration. The preset operational status may further include a second preset operational status, the second preset operational status is a status in which a Bluetooth audio mode is provided and the Bluetooth is unpaired, and a function corresponding to the second preset operational status is a function for Bluetooth pairing. The preset operational status may further include a third preset operational status, the third preset operational status is a status in which the device is in system error, and a function corresponding to the third preset operational status is a function for system reset. At step S102, the device automatically and sequentially determines whether the current operational status is one of the plurality of preset operational statuses.

Specifically, at step S1021, determine whether the current operational status of the device is a status in which a WiFi mode is provided and a WiFi configuration is uncompleted. If yes, execute step S1041 of configuring the wildcard button with a WiFi configuration start function. For example, when the device, such as a loudspeaker, is in a WiFi audio mode, the wildcard button is configured with the WiFi configuration start function; and by pressing the wildcard button, a system starts the WiFi configuration, for example, by running Soft AP. If not, end the step.

At step S1022, determine whether the current operational status of the device is a status in which a Bluetooth audio mode is provided and a Bluetooth is unpaired. If yes, execute step S1042 of configuring the wildcard button with the WiFi pairing function. For example, when the device, such as the loudspeaker, is in the WiFi audio mode and a paired device list is empty, the wildcard button is configured with the WiFi pairing function; and the system may enter a Bluetooth pairing mode by pressing the wildcard button. If not, end the step.

At step S1023, determine whether the current operational status of the device is a status in which the device is in a system error. If yes, execute step S1043 of configuring the wildcard button with a system reset function. If not, the current operational status of the device does not pertain to anyone of the preset operational statuses. By means of the above steps S102 and S104, the wildcard button may provide a corresponding function for a user in different current operational statuses of the device, such as the WiFi mode, the Bluetooth audio mode or the system error mode, so that the device use process may be more smoothly.

When the current operational status of the device does not pertain to anyone of the preset operational statuses, execute step S1061 of playing the voice prompt for an end user to choose a function for the wildcard button.

At step S1062, determine whether the wildcard button is pressed during the voice prompt. If not, execute step S1063 of continuously playing the voice prompt and going back to the step S1062; and if yes, execute step S1064.

At step S1064, when the wildcard button is pressed by the end user presses, map a function of the wildcard button according to a voice prompt menu index to configure the chosen function to the wildcard button.

At step S1065, ask, via a voice, whether the end user confirms the chosen function for the wildcard button.

At step S1066, determine whether the end user confirms a choice. If yes, execute step S1067 of configuring the chosen function to the wildcard button and ending the step; and if not, execute step S1068 of not configuring the function to the wildcard button and ending the step.

In summary, the method 100 provided by the application can automatically configure a wildcard button with a function required by the current operational status according to a current operational status of a device and, thus, the wildcard button may still work automatically and smartly even when the wildcard button is not configured with a function. In addition, the wildcard button may be configured as a function commonly used by an end user or a function favored by the user without a network or a mobile app. The method for configuring the function of the wildcard button is simple, economic and effective.

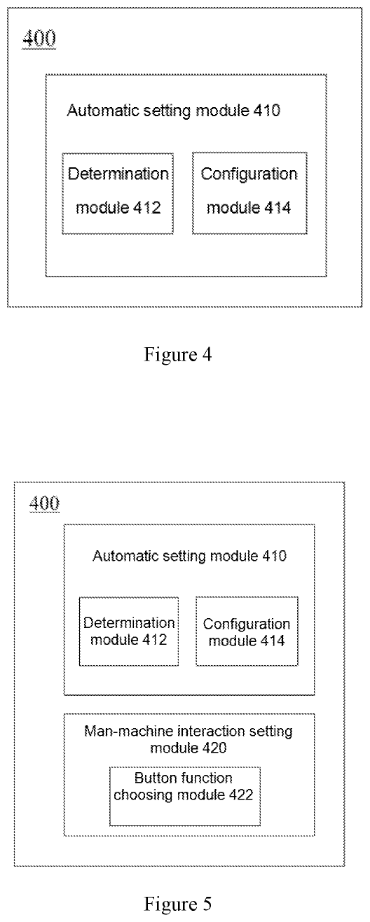

As shown in FIG. 4, according to an embodiment of the application, a setting apparatus 400 for a button function is further provided, including an automatic setting module 410. The automatic setting module 410 automatically sets, according to an operational status of a device having a wildcard button, a function of the wildcard button. The automatic setting module 410 may include a determination module 412 and a configuration module 414. The determination module 412 determines whether a current operational status of the device pertains to a preset operational status in a case where the wildcard button is pressed and is not configured with a button function. The configuration module 414 configures the wildcard button with a button function corresponding to the preset operational status when the current operational status of the device pertains to the preset operational status.

In an embodiment, the preset operational status includes a first preset status, a second preset status and a third preset status; the first preset operational status may be a status in which a Bluetooth audio mode is provided and a Bluetooth is unpaired, and a function corresponding to the first preset operational status is function for Bluetooth pairing. The second preset operational status may be a status in which a WiFi mode is provided and a WiFi configuration is uncompleted, and a function corresponding to the second preset operational status is a function for start WiFi configuration. The third preset operational status may be a status in which the device is in a system error, and a function corresponding to the third preset operational status is a function for system reset.

As shown in FIG. 5, the setting apparatus 400 may further include a human-machine interaction setting module 420. When the determination module 412 determines that the current operational status of the device is not the preset operational status, the human-machine interaction setting module 420 configures the wildcard button with a button function chosen by a user under an environment without a network and/or an app.

The human-machine interaction setting module 420 includes a button function choosing module 422, configured to choose, in response to that the user uses a voice command or presses the wildcard button during a voice menu prompt, a button function to be configured to the wildcard button.

According to an embodiment of the application, a storage medium is further provided; and the storage medium stores a program, and executes the program to complete the method for setting the button function of the device.

The foregoing is only preferred embodiments of the present application and is not intended to limit the present application, and any modifications, equivalent substitutions, improvements and the like within the spirit and principles of the present application are intended to be embraced by the protection scope of the present application.

1-13. (canceled)

14. A method of automatically setting a button function for a device comprising:
determining one or more preset operational statuses of the device;
determining, when a wildcard button is pressed, whether the wildcard button is configured with a button function and, if it is not,
determining if the current operational status of the device is the one or is one of the preset operational statuses and, if so,
allocating a function to the wildcard button corresponding to the determined operational status.

15. The method of setting a button function for a device as claimed in claim 14, wherein a plurality of preset operational statuses are determined and given a hierarchy, whereby the button function assigned to the wildcard button is determined by the highest of the operational statuses in the hierarchy.

16. The method of setting a button function for a device as claimed in claim 14, further comprising a first preset operational status comprising a status in which the device has a WiFi mode but a WiFi configuration is uncompleted, and the function assigned to the device comprises actuating a WiFi configuration.

17. The method of setting a button function for a device according to claim 16, wherein a second preset operational status comprises an operational status in which a Bluetooth audio mode is provided and Bluetooth pairing is unready, and the function assigned to the wildcard button comprising actuating Bluetooth pairing.

18. The method of setting a button function for a device according to claim 17, wherein a third preset operational status comprises a status in which a device is in an error state, the function assigned to the wildcard button is a reset function for the system.

19. The method of setting a button function for the device according to claim 18, wherein the error state is a state system error.

20. The method of setting a button function for a device according to claim 17, wherein the first preset operational status is accorded a higher place in than hierarchy than the second preset operational status, and the second operational status is accorded a higher place in the hierarchy than the third preset operational status.

21. The method of setting a button function for a device according to claim 14, further comprising, when the current operational status of the device is not any of the preset operational statuses, enabling a user to select the button function allocated to the wildcard button.

22. The method of setting a button function for a device according to claim 21, wherein the button function selected by a user and allocated to the wildcard button is done in an environment without a network and/or mobile application set up.

23. The method of setting a button function for a device according to claim 21, wherein, selecting a button function chosen by a user is done in response to a user voice and/or pressing the wildcard button during a voice menu notification.

24. The method of setting a button function for a device according to claim 23, wherein the button function selected by the user is any one of: Bluetooth pairing, WiFi connection, mute and/or play/pause function.

25. A device having means for setting a button function comprising;
means for automatically setting a function for a wildcard button of a device based on an operational status of the device, comprising;
means for determining whether a current operation status of the device is one or more preset operational statuses;
means for determining when the wildcard button is pressed and is un-configured with a button function; and
a configuration means assigned to configure the wildcard button with a button function appropriate to a preset operational state which the device is currently in.

26. The device having means for setting a button function according to claim 25, wherein there is one preset operational status or there are a plurality of preset operational statuses.

27. The device having means for setting a button function according to claim 26, wherein the preset operational status comprises a first preset status in which a WiFi mode is provided and a WiFi configuration is uncompleted, and the function corresponding to this operational status allocated to the wildcard button is actuate the WiFi configuration;
a second preset operational status in which a Bluetooth audio mode is provided and a Bluetooth pairing is unread, and the function corresponding to the second preset operational status allocated to the wildcard button is to accurate Bluetooth pairing; and
a third preset operational status is the status in which the device is in a system error mode, and the function corresponding to this status allocated to the wildcard button is a reset function.

28. The device having means for setting a button function according to claim 27, wherein the first present operation status, the second preset operational status and the third preset operational status are in a hierarchy, and the function assigned to the wildcard button is the function associated with the highest operational status in the hierarchy the device is in when the wildcard button is pressed and is un-configured with a function.

29. The device having means for setting a button function according to claim 25, further comprising;
a human-machine interactive setting module, wherein when it is determined that the current operational status of the device is not one of the preset operational statuses, the human-machine interactive setting module assigns a button function selected by a user to the wildcard button.

30. The device having means for setting a button function according to claim 29, wherein the button function is selected by a user in an environment without a network connection and/or mobile application.

31. The device having means for setting a button function according to claim 29, wherein assigning function to the wildcard button is done in response to a user voice command or by pressing the wildcard button during a voice menu notification.

32. The device having means for setting a button function according to claim 25, where the device is a loudspeaker.

33. A loudspeaker configured to use a method of setting a button function as claimed in claim 14.

34. A computer/readable storage medium, storing a program, wherein the program is executable to perform the method as claimed in claim 14.
